(19) United States
(12) Patent Application Publication
(10) Pub. No.: US 2020/0380437 A1
(43) Pub. Date: Dec. 3, 2020

(54) BUSINESS PROCESS DESIGN SUPPORT METHOD AND BUSINESS PROCESS DESIGN SUPPORT APPARATUS

(71) Applicant: Hitachi, Ltd., Tokyo (JP)

(72) Inventors: Yusuke JIN, Tokyo (JP); Yuri OKADA, Tokyo (JP); Nishio YAMADA, Tokyo (JP)

(21) Appl. No.: 16/957,407

(22) PCT Filed: Nov. 22, 2018
(86) PCT No.: PCT/JP2018/043210

§ 371 Date: Jun. 24, 2020

(30) Foreign Application Priority Data
Jan. 26, 2018 (JP) 2018-011467

(51) Int. Cl. G06Q 10/06; G06Q 10/10

(52) U.S. Cl. CPC G06Q 10/0637; G06Q 10/10

(57) ABSTRACT

A business process design support method for supporting a design of a business process includes: a computer receiving definition information of the business process; the computer extracting one or more data items, one or more roles to execute processing, contents of tasks to be processed by the role for each data item, and a relationship between sending and reception of a message among roles from the definition information to generate a model of the business process; the computer selecting an element of information management set in advance; the computer executing a simulation to apply the selected element of information management to the model; and the computer determining whether the selected element of information management is applicable to the model based on results of the simulation.

### CROSS-REFERENCE TO RELATED APPLICATIONS

The present application claims priority from Japanese Patent Application No. 2018-011467 filed on Jan. 26, 2018, contents of which are incorporated into the present application by reference.

### TECHNICAL FIELD

The present invention relates to a technique using a blockchain.

### BACKGROUND ART

In recent years, techniques using a blockchain having characteristics such as immutability, transparency, fault tolerance, and decentralization have become widespread. The blockchain is a technique for implementing distributed ledger management on a peer to peer (P2P) network. The blockchain has characteristics such as consistency, immutability, and transparency of recorded information by creating transactions including recorded information and connecting the transactions in a chain shape based on electronic signatures and hash values.

Regarding the development of an application using the blockchain, for example, Non-Patent Literature 1 is known. Non-Patent Literature 1 discloses a technique of defining a change in a state of asset with a state chart and managing the change in the state using a blockchain.

Research on applying the blockchain to business processes is also in progress. For example, Non-Patent Literature 2 discloses a technique for describing a business process in business process modeling notation (BPMN), converting the BPMN to a model according to a simplified rule, and converting the model into a program (smart contract).

### CITATION LIST

### Non-Patent Literature

Non-Patent Literature 1: By Takaaki Tateishi, Shin Saitou, Futoshi Iwama, Shunichi Amano, Shohei Ohsawa, Sachiko Yoshihama, “Practice and Future Task of Blockchain Application Development”, published by Information Processing Society of Japan, Software Engineering Sypodium 2017 Collection of Papers, pp. 204 to 211, Aug. 23, 2017

Non-Patent Literature 2: By Luciano Garcia-Banuelos, Alexander Ponomarev, Marlon Dumas, Ingo Weber, “Optimized Execution of Business Processes on Blockchain”, [online], [search on Jan. 4, 2018]

### SUMMARY OF INVENTION

### Technical Problem

In the above Non-Patent Literature 1, it is assumed that a target (asset to be managed, a manager, and a status type) described in a state chart is determined. In Non-Patent Literature 2, it is assumed that a flow of an organization (role) and business related to a To-Be business process described in the BPMN is determined.

Therefore, in the related examples in Non-Patent Literatures 1 and 2, it is necessary to complete a design of a To-Be business process to which the blockchain is applied, and there has been a problem that a blockchain technique cannot be applied to an existing business process to easily develop the To-Be business process.

The invention is made in view of the above problems, and an object of the invention is to support development of a business process taking advantage of characteristics of a blockchain.

### Solution to Problem

The invention provides a business process design support method for supporting a design of a business process by a computer including a processor, a memory, and a storage device, in which the business process design support method includes: a first step of the computer receiving definition information of the business process; a second step of the computer extracting one or more data items, one or more roles to execute processing, contents of tasks to be processed by the role for each data item, and a relationship between sending and reception of a message among roles from the definition information to generate a mode of the business process; a third step of the computer selecting an element of information management set in advance; a fourth step of the computer executing a simulation to apply the selected element of information management to the model; and a fifth step of the computer determining whether the selected element of information management is applicable to the model based on results of the simulation.

### Advantageous Effect

According to the invention, it is possible to propose a new business process to which elements of a blockchain are applied based on an analysis result of an As-Is business process.

### BRIEF DESCRIPTION OF DRAWINGS

FIG. 1 is a block diagram showing an embodiment of the invention and showing an example of a business process design support system.

FIG. 2 is a block diagram showing the embodiment of the invention and showing an example of a business process design support apparatus.

FIG. 3 is a block diagram showing the embodiment of the invention and showing an example of software stored in a storage device.

FIG. 4 is a flowchart showing the embodiment of the invention and showing an example of processing performed by the business process design support apparatus.

FIG. 5 is a flowchart showing the embodiment of the invention and showing an example of As-Is business process analysis processing performed in step S2 in FIG. 4.

FIG. 6 is a flowchart showing the embodiment of the invention and showing an example of data lifecycle analysis processing performed in step S3 in FIG. 4.

FIG. 7 is a flowchart showing the embodiment of the invention and showing an example of intermediator exclusion processing performed in step S6 in FIG. 4.

FIG. 8 is a flowchart showing the embodiment of the invention and showing an example of task transfer processing performed in step S6 in FIG. 4.

FIG. 9 is a flowchart showing the embodiment of the invention and showing an example of selection processing performed in step S9 in FIG. 4.

FIG. 10 is a flowchart showing the embodiment of the invention and showing an example of pattern addition processing.

FIG. 11 is a diagram showing the embodiment of the invention and showing an example of transition of information of an As-Is business process.

FIG. 12 is a diagram showing the embodiment of the invention and showing an example of transition of information of a To-Be business process.

FIG. 13 is a schematic diagram showing the embodiment of the invention and showing an example of a data lifecycle of an As-Is business process.

FIG. 14 is a schematic diagram showing the embodiment of the invention and showing an example of a data lifecycle after intermediator exclusion.

FIG. 15 is a schematic diagram showing the embodiment of the invention and showing an example of a data lifecycle after task transfer.

FIG. 16 is a diagram showing the embodiment of the invention and showing an example in which the As-Is business process is expressed in XML.

FIG. 17 is a diagram showing the embodiment of the invention and showing an example of a role definition table.

FIG. 18 is a diagram showing the embodiment of the invention and showing an example of a task definition table.

FIG. 19 is a diagram showing the embodiment of the invention and showing an example of a role-task assignment definition table.

FIG. 20 is a diagram showing the embodiment of the invention and showing an example of a data item definition table.

FIG. 21 is a diagram showing the embodiment of the invention and showing an example of a data set definition table.

FIG. 22 is a diagram showing the embodiment of the invention and showing an example of a message definition table.

FIG. 23 is a diagram showing the embodiment of the invention and showing an example of a message sending cost calculation table.

FIG. 24 is a diagram showing the embodiment of the invention and showing an example of a task execution cost calculation table.

FIG. 25 is a diagram showing the embodiment of the invention and showing an example of a data lifecycle definition intermediate table.

FIG. 26 is a diagram showing the embodiment of the invention and showing an example of a data lifecycle definition table.

FIG. 27 is a diagram showing the embodiment of the invention and showing an example of a business transformation pattern definition table.

FIG. 28 is a diagram showing the embodiment of the invention and showing an example of a data lifecycle definition simulation table after the intermediator exclusion.

FIG. 29 is a diagram showing the embodiment of the invention and showing an example of a data lifecycle definition simulation table after the task transfer.

FIG. 30 is a diagram showing the embodiment of the invention and showing an example of the role-task assignment definition table after a simulation result is applied.

FIG. 31 is a diagram showing the embodiment of the invention and showing an example of the data set definition table after the simulation result is applied.

FIG. 32 is a diagram showing the embodiment of the invention and showing an example of the message definition table after the simulation result is applied.

FIG. 33 is a diagram showing the embodiment of the invention and showing an example of a business process input screen.

FIG. 34 is a diagram showing the embodiment of the invention and showing an example of a message flow analysis screen.

FIG. 35 is a diagram showing the embodiment of the invention and showing an example of a simulation result display screen.

FIG. 36 is a diagram showing the embodiment of the invention and showing an example of the task transfer processing.

### DESCRIPTION OF EMBODIMENTS

An embodiment of the invention will be described below with reference to the accompanying figures.

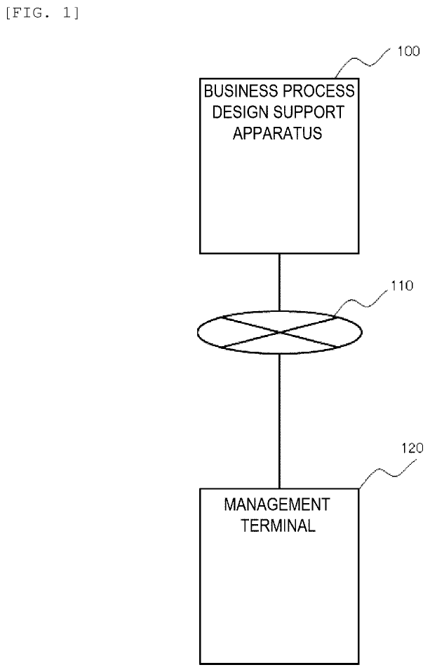

FIG. 1 is a block diagram showing the embodiment of the invention and showing an example of a business process design support system. The business process design support system includes a business process design support apparatus 100 that proposes a new business process (a To-Be business process) from an As-Is business process, a management terminal 120 that manages the business process design support apparatus 100, and a network 110 that connects the business process design support apparatus 100 and the management terminal 120.

### Configuration of Business Process Design Support Device

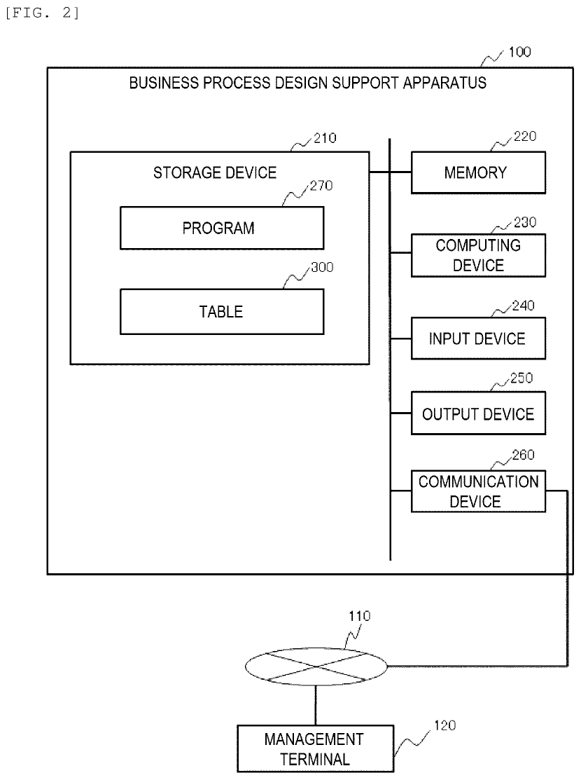

FIG. 2 is a block diagram showing an example of the business process design support apparatus 100. The business process design support apparatus 100 includes a memory 220, a computing device 230, a storage device 210, an input device 240, an output device 250, and a communication device 260.

A program 270 that executes design support of a business process and a table 300 used by the program 270 are stored in the storage device 210. The computing device 230 executes the program 270 loaded into the memory 220 to support the design of the business process.

The input device 240 is implemented by a mouse, a keyboard, a touch panel, and the like. The output device 250 is implemented by a display or the like. The communication device 260 is connected to the network 110 to communicate with the management terminal 120.

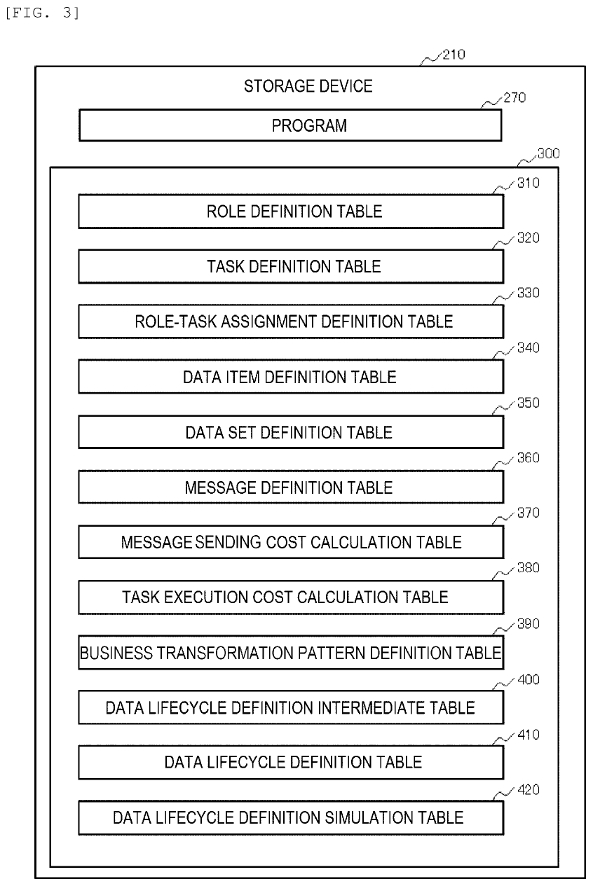

FIG. 3 is a block diagram showing an example of software stored in the storage device 210. The program 270 that performs the design support of the business process and the table 300 used by the program 270 are stored in the storage device 210.

The table 300 includes a role definition table 310, a task definition table 320, a role-task assignment definition table 330, a data item definition table 340, a data set definition table 350, a message definition table 360, a message sending cost calculation table 370, a task execution cost calculation table 380, a business transformation pattern definition table 390, a data lifecycle definition intermediate table 400, a data lifecycle definition table 410, and a data lifecycle definition simulation table 420. Details of each table will be described below.

### Outline of Processing

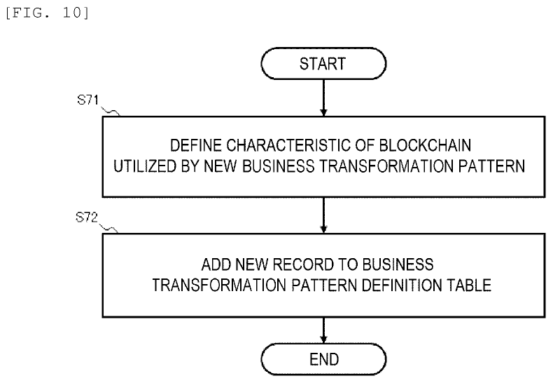

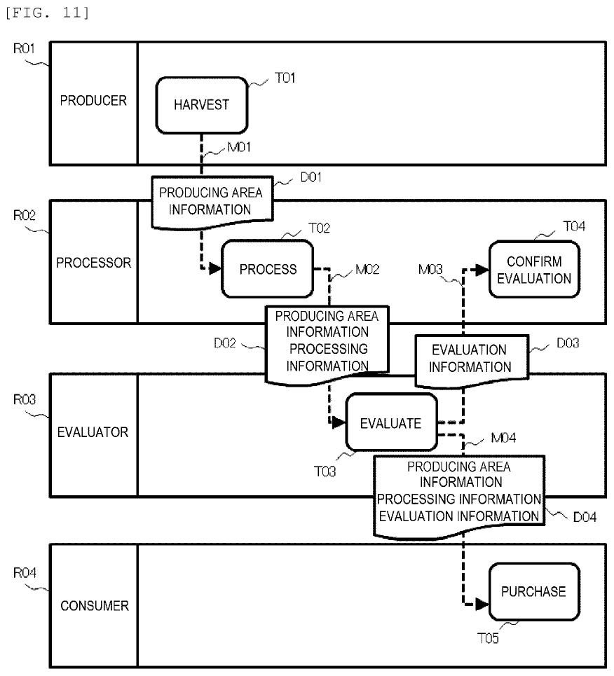

An outline of design support of a To-Be business process performed by the business process design support apparatus 100 will be described with reference to FIGS. 11 and 12. FIG. 11 is a diagram showing an example of transition of information of the As-Is business process. FIG. 11 shows an example of the As-Is business process executed by four roles of a producer R01, a processor R02, an evaluator R03, and a consumer R04 which are roles (organizations or subjects of processing) that executes the business process.

In the As-Is business process, first, the producer R01 harvests a raw material (for example, crops) (T01), and generates producing area information D01. The producer R01 attaches the producing area information D01 to the raw material and ships the raw material to the processor R02 (M01). The processor R02 processes the raw material to which the producing area information D01 is attached to produce a product (T02).

The processor R02 generates processing information of the product and generates shipping information D02 obtained by adding the processing information to the producing area information D01 from the producer R01. Then, the processor R02 attaches the shipping information D02 to the product and delivers the product to the evaluator R03 (M02).

The evaluator R03 evaluates the product (T03), and generates evaluation information D03. The evaluator R03 notifies the processor R02 of the evaluation information D03 (M03). The processor R02 receives the evaluation information D03 and confirms the evaluation.

The evaluator R03 generates sales information D04 obtained by adding the evaluation information D03 to the shipping information D02 from the processor R02, and provides the sales information D04 to the consumer R04 (M04). The consumer R04 receives the sales information D04 and purchases the product (T05).

The business process design support apparatus 100 analyzes the As-Is business process to be described below to specify a source and a destination of information and specify an operation (refer, generate) for information for each role and determine whether characteristics (elements) of a blockchain is applicable.

As a result of executing simulation of applying the blockchain to the As-Is business process, if the elements of the blockchain are applicable to the To-Be business process, the business process design support apparatus 100 proposes the To-Be business process based on a simulation result.

FIG. 12 is a diagram showing an example of transition of information of the To-Be business process as a result of simulation. FIG. 12 shows the transition of information when the characteristics of the blockchain are applied to the As-Is business process to make the As-Is business process into the To-Be business process.

In the present embodiment, as the characteristics of the blockchain to be described below, an example is shown in which decentralization and transparency are used. As the decentralization and the transparency, intermediator exclusion of excluding the role that simply intermediates with information is applied. As the decentralization, task transfer of moving processing executable by another role is applied. Detailed processing contents of the intermediator exclusion and the task transfer will be described below.

In FIG. 12, among the roles shown in FIG. 11, message sending and reception are updated such that production area information D05 generated by the producer R01 is transmitted (M01, M05, M06) to the processor R02 and the consumer R04 by executing intermediator exclusion processing.

Further, in FIG. 12, among the roles shown in FIG. 11, evaluation generation processing (T03) is moved to the role of the consumer R04 by executing the task transfer, and the evaluator R03 that only transfers production information and the processing information is deleted. Accordingly, the To-Be business process is modified to be performed by three roles of the producer R01, the processor R02, and the consumer R04.

In the To-Be business process, the producer R01 harvests the raw material (for example, the crops) (T01), and generates the producing area information D05. The producer R01 attaches the producing area information D05 to the raw material and ships the raw material to the processor R02 (M01). The producer R01 distributes the producing area information D05 to the consumer R04 (M05, M06).

The processor R02 processes the raw material to produce a product (T02), and generates processing information D06 of the product. The processor R02 distributes the processing information D06 to the consumer R04 (M02).

The consumer R04 receives the processing information D06 to generate evaluation information D07, and distributes the evaluation information D07 to the processor R02.

The business process design support apparatus 100 proposes the To-Be business process in which the evaluator R03 that performs only the evaluation is excluded and the evaluation (T03) performed by the evaluator R03 is moved to the consumer R04 by executing the intermediator exclusion and the task transfer to which the decentralization and the transparency are applied. The producing area information D05 is provided directly to the processor R02 and the consumer R04 by the producer R01, so that the transparency and fault tolerance can be improved.

Next, the characteristics of the blockchain according to the present embodiment will be described. As in the related examples, the technique of the blockchain is a distributed ledger (information) management system in which a P2P network, a consensus algorithm, and anti-counterfeiting and encryption techniques are combined.

In the present embodiment, the blockchain is applied to a supply chain from the producer R01 to the consumer R04, but the invention is not limited to the supply chain.

In the present embodiment, among the characteristics of the blockchain, an example is shown in which the decentralization, the transparency, immutability, the fault tolerance, and automatic execution (automatic transaction) are used. First, the decentralization prohibits a specific role from monopolizing management of data to allow each role participating in the blockchain to manage the data.

In the example in FIG. 11, one organization named the evaluator R03 monopolizes the evaluation of the product, and in contrast, in the example in FIG. 12, a wide range of opinions of a plurality of consumers R04 can be reflected in the evaluation without depending on a specific role (an organization).

Next, the transparency indicates that the information generated by each role is published to all roles and shared by all roles. The roles participating in the business process can view all information and ensure consistency of recorded information.

As in the related examples, the immutability prevents tampering of data by generating transactions in the roles and connecting the transactions in a chain shape based on electronic signatures and hash values. It is possible to prevent willingness to tamper the data by publishing the information generated by the roles.

The fault tolerance is to prevent damage or loss of data even if a fault occurs in a part of the roles by each role holding data or a copy of the data in the roles participating in the blockchain.

The automatic execution (the automatic transaction) indicates that a transaction or information is issued after a determination result relating to a plurality of necessary conditions are aggregated. Alternatively, an agreement with issued information may be performed efficiently.

### Configuration of Table

Next, details of the table 300 stored in the storage device 210 will be described.

FIG. 17 is a diagram showing an example of the role definition table 310. In the role definition table 310, elements participating in the business process, such as organizations and people participating in the business process, are defined. The role definition table 310 is information generated by the program 270.

The role definition table 310 includes, in one record, a role ID 311 for storing an identifier of the role, a role name 312 for storing a name of the role, and important role flag 313 for storing an index related to the importance of the role.

When the important role flag 313 is “1”, it indicates that the role is an important role, and when the important role flag 313 is “0”, it indicates that the role is not important.

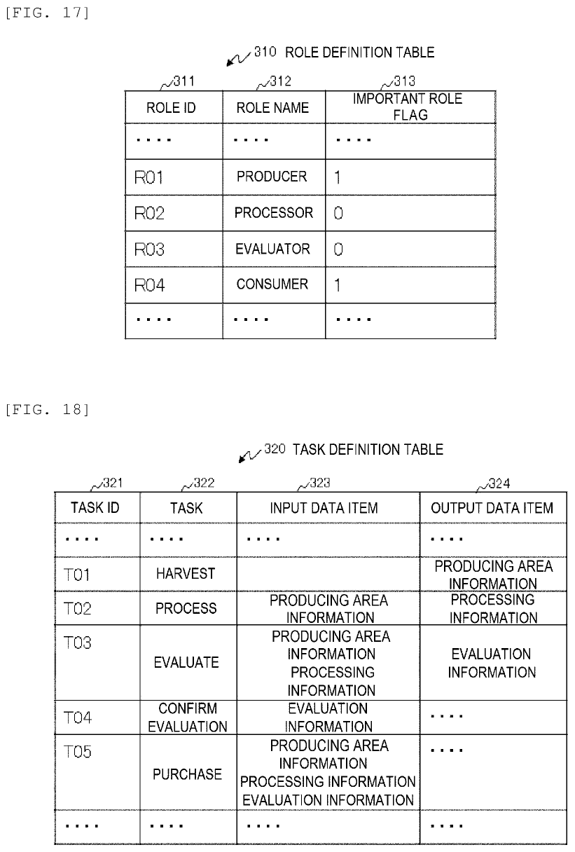

FIG. 18 is a diagram showing an example of the task definition table 320. In the task definition table 320, processing constituting the business process are defined. The task definition table 320 is information generated by the program 270.

The task definition table 320 includes, in one record, a task ID 321 for storing an identifier of a task, a task 322 for storing a name of the task, an input data item 323 for storing a data item name to be input to the task, and an output data item 324 for storing a data item name to be output by the task.

The task ID 321 corresponds to the descriptions of FIGS. 11 and 12. A plurality of data item names can be stored in the input data item 323 and the output data item 324. It is sufficient that a data item name is stored in at least one of the input data item 323 and the output data item 324.

FIG. 19 is a diagram showing an example of the role-task assignment definition table 330. In the role-task assignment definition table 330, relationships between the processing constituting the business process and the roles for executing the processing are defined. The role-task assignment definition table 330 is information generated by the program 270.

The role-task assignment definition table 330 includes, in one record, a task ID 331 for storing the identifier of the task, a task name 332 for storing the name of the task, a role ID 333 for storing the identifier of the role to perform the task, and a role name 334 for storing the name of the role.

The role ID 333, the role name 334, the task ID 331, and the task name 332 correspond to the descriptions of FIGS. 11 and 12.

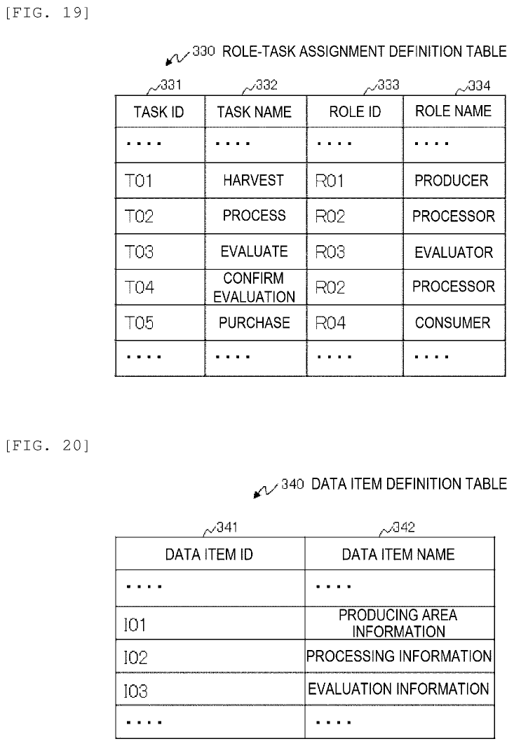

FIG. 20 is a diagram showing an example of the data item definition table 340. In the data item definition table 340, data items generated by each role are defined. The data item definition table 340 is information generated by the program 270.

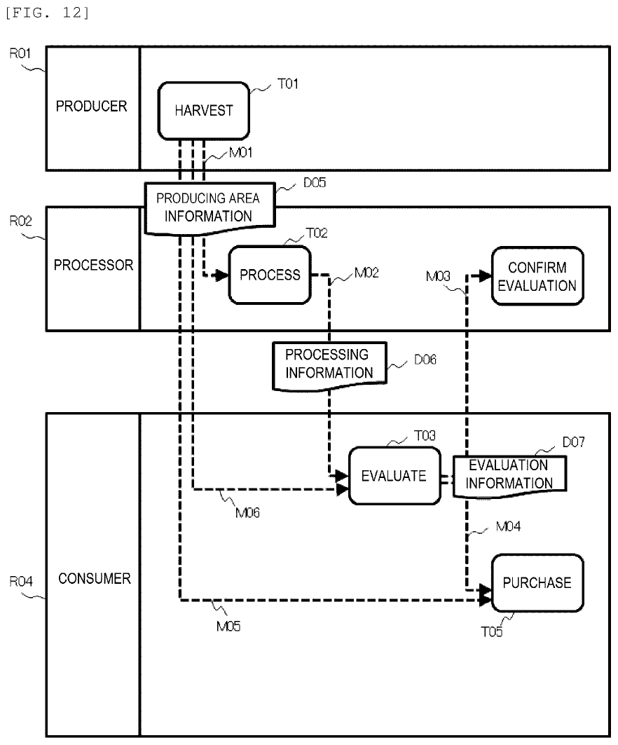

The data item definition table 340 includes, in one record, a data item ID 341 for storing an identifier of a data item and a data item name 342 for storing an item name of data. The data item ID 341 and the data item name 342 correspond to the descriptions of FIGS. 13 to 15.

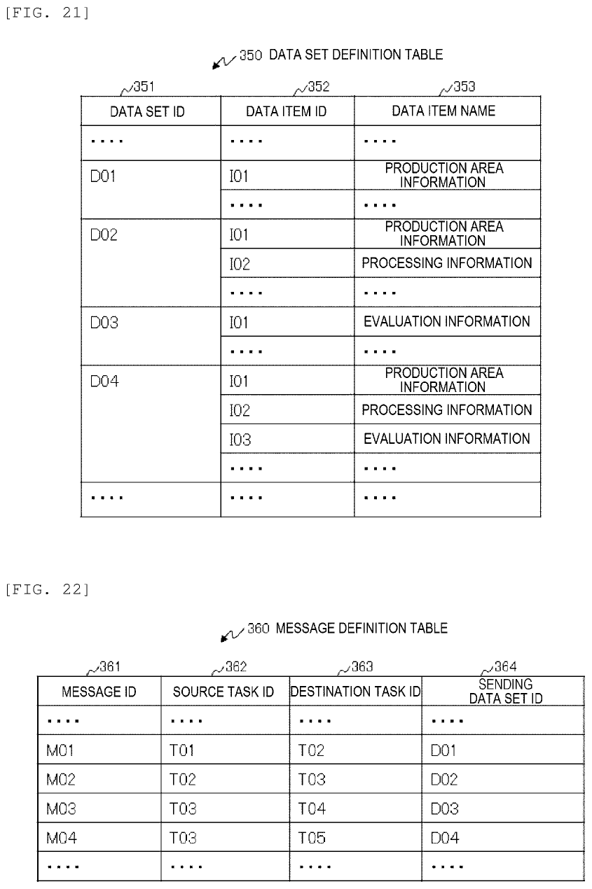

FIG. 21 is a diagram showing an example of the data set definition table 350. In the data set definition table 350, a relationship between the data item generated by each role and a data set to be transmitted and received is defined. The data set definition table 350 is information generated by the program 270.

The data set definition table 350 includes, in one record, a data set ID 351 for storing an identifier of the data set, a data item ID 352 for storing the identifier of the data item, and a data item name 353 for storing the item name of the data. The data set ID 351, the data item ID 352, and the data item name 353 correspond to the descriptions of FIGS. 11 and 12.

FIG. 22 is a diagram showing an example of the message definition table 360. In the message definition table 360, messages transmitted and received among the roles are defined. The message definition table 360 is information generated by the program 270.

The message definition table 360 includes, in one record, a message ID 361 for storing an identifier of a message, a source task ID 362 for storing an identifier of a task that is a source of the message, a destination task ID 363 for storing an identifier of a task that is a destination of the message, and a sending data set ID 364 for storing identifiers of data sets included in the message.

The message ID 361, the source task ID 362, the destination task ID 363, and the sending data set ID 364 correspond to the descriptions of FIGS. 11 and 12.

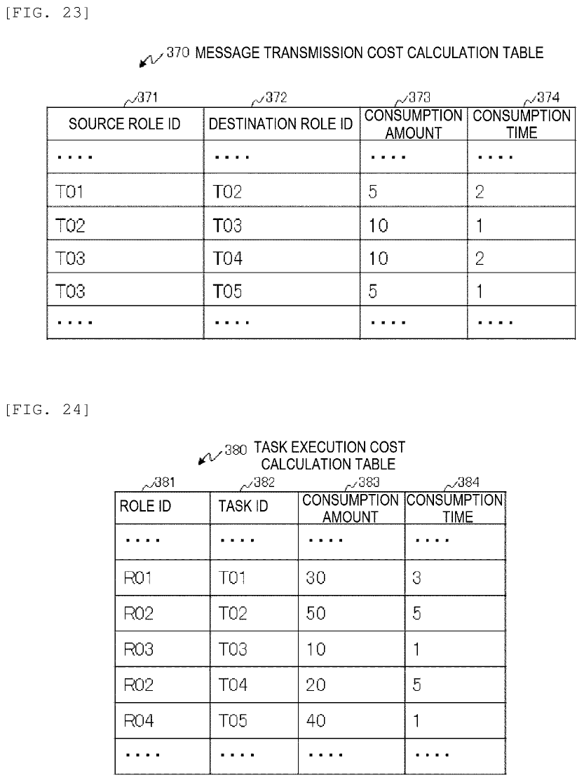

FIG. 23 is a diagram showing an example of the message sending cost calculation table 370. In the message sending cost calculation table 370, cost for transmitting and receiving messages among the roles is defined. The message sending cost calculation table 370 is information that is set in advance by a manager or the like of the business process design support system.

The message sending cost calculation table 370 includes, in one record, a source role ID 371 for storing an identifier of a role as the source, a destination role ID 372 for storing an identifier of a role as the destination, a consumption amount 373 for storing an amount as cost required for the sending, and a consumption time 374 for storing time as cost required for the sending.

In the present embodiment, an example is shown in which the To-Be business process (the simulation result) is evaluated by a key performance indicator (KPI), and the consumption amount and the consumption time are used as cost indices of the KPI, but the invention is not limited thereto, and a field may be set according to the number of indices.

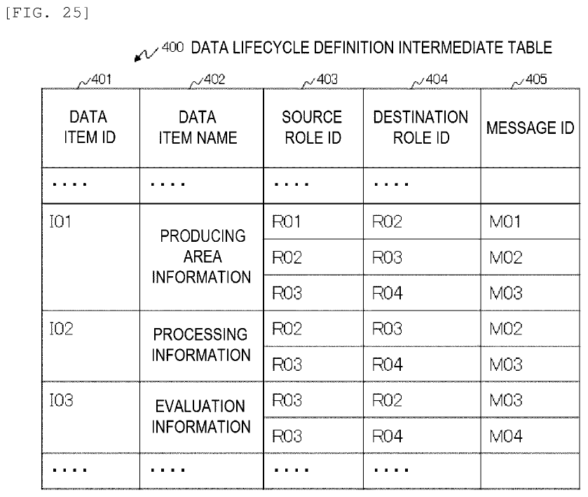

FIG. 24 is a diagram showing an example of the task execution cost calculation table 380. In the task execution cost calculation table 380, the cost of processing executed by each role is defined. The task execution cost calculation table 380 is information that is set in advance by the manager or the like of the business process design support system.

The task execution cost calculation table 380 includes, in one record, a role ID 381 for storing the identifier of the role to execute the task, a task ID 382 for storing an identifier of a task to be executed, a consumption amount 383 for storing an amount as cost required for executing the task, and a consumption time 384 for storing time as cost required for executing the task.

As in the message sending cost calculation table 370, a field may be set according to the number of the indices of the KPI.

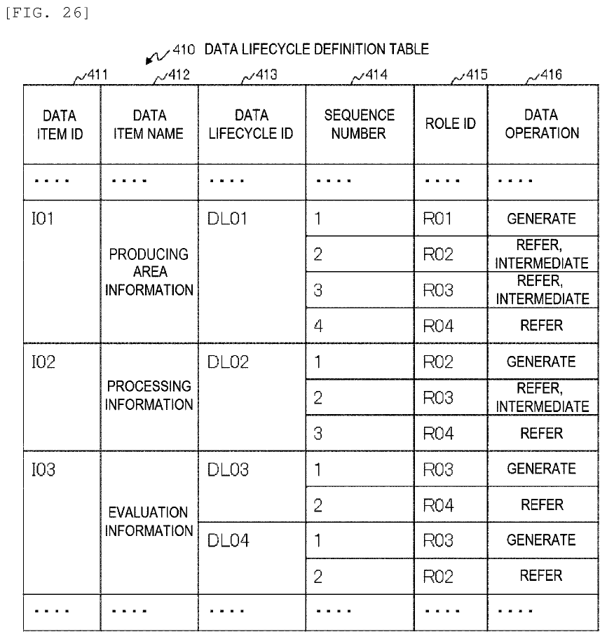

FIG. 25 is a diagram showing an example of the data lifecycle definition intermediate table 400. A data item path (a role ID) included in the message is stored in the data lifecycle definition intermediate table 400. The data lifecycle definition intermediate table 400 is information generated by the program 270.

The data lifecycle definition intermediate table 400 includes, in one record, a data item ID 401 for storing the identifier of the data item to be transmitted and received among the roles, a data item name 402 for storing the item name of the data, a source role ID 403 for storing an identifier of a role as a source of the data item, a destination role ID 404 for storing an identifier of a role as a destination of the data item, and a message ID 405 for storing an identifier of a message including the data item.

In the shown example, the data item ID 401 and the message ID 405 are sorted. A lifecycle of data indicates a path from generation of the data item in a certain role to a final transfer of the data item to a role. By referring to the data lifecycle definition intermediate table 400, for example, the source role ID 371 of the data item and the destination role ID 404 to finally receive the data item can be specified.

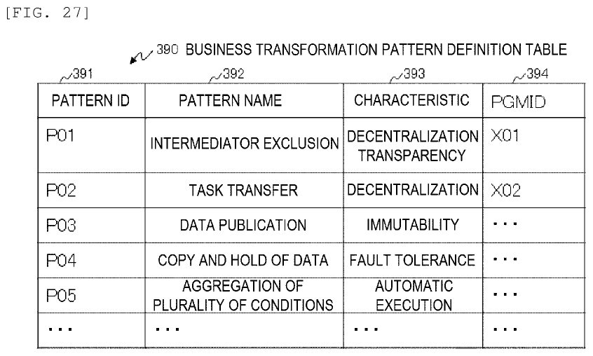

FIG. 26 is a diagram showing an example of the data lifecycle definition table 410. In the data lifecycle definition table 410, operations of the roles to the data item to be transmitted and received among the roles and an order of the roles are stored. The data lifecycle definition table 410 is information generated by the program 270.

The data lifecycle definition table 410 includes, in one record, a data item ID 411 for storing the identifier of the data item to be transmitted and received among the roles, a data item name 412 for storing the item name of the data, a data lifecycle ID 413 for storing an identifier of a lifecycle of the data item, a sequence number 414 of the data item, a role ID 415 for storing an identifier of a role to handle the data item, and a data operation 416 for storing an operation to the data item to be performed by the role.

In the shown example, the data item ID 411 and the sequence number 414 are sorted, and it is possible to specify the operation to be performed by the role who finally receives the data item from the source of the data item.

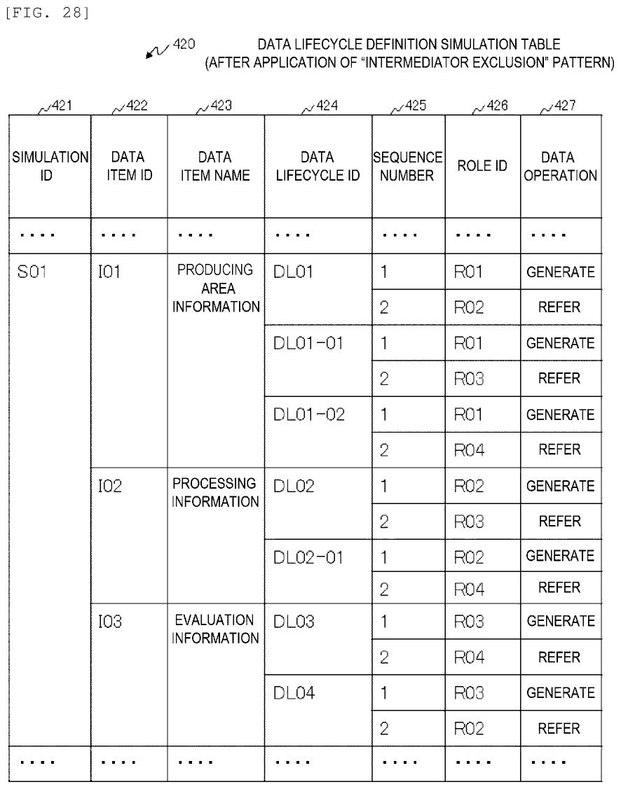

FIG. 27 is a diagram showing an example of the business transformation pattern definition table 390. In the business transformation pattern definition table 390, a correspondence relationship between the characteristics of the blockchain (the distributed ledger (information) management) to be applied to the As-Is business process in order to generate the To-Be business process and a simulation program that applies elements (business transformation patterns) of the blockchain corresponding to the characteristics is defined. The business transformation pattern definition table 390 is information that is set in advance by the manager or the like of the business process design support system.

The business transformation pattern definition table 390 includes, in one record, a pattern ID 391 for storing an identifier of a business transformation pattern, a pattern name 392 for storing a name of the pattern, a characteristic 393 for storing a characteristic of the blockchain corresponding to the pattern, and a PGMID 394 for storing an identifier of the simulation program corresponding to the characteristic. A plurality of characteristics can be stored in the characteristic 393.

The simulation program specified by the PGMID 394 applies the pattern name 392 corresponding to the characteristic 393 of the blockchain to the As-Is business process to try to generate the To-Be business process.

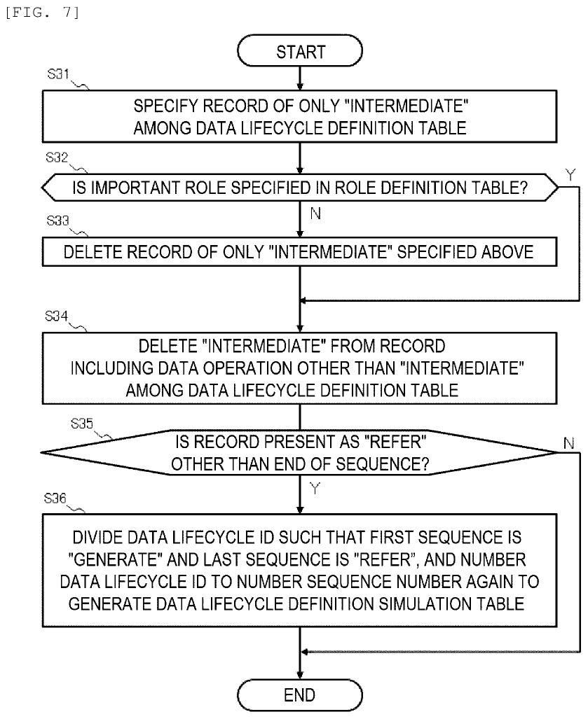

In the present embodiment, the PGMID 394=“X01” corresponding to the pattern ID 391=“P01” indicates an example of the intermediator exclusion processing shown in FIG. 7, and the PGMID 394=“X02” corresponding to the pattern ID 391=“P02” indicates an example of the task transfer processing shown in FIG. 8.

Showing of the pattern ID 391=characteristics 393 of “P03” to “P05”=“immutability”, “fault tolerance”, and “automatic execution” are omitted, but the simulation program maybe any simulation program that tries to generate a business process (a To-Be business process) when the pattern name 392 corresponding to the characteristic 393 is applied to the As-Is business process using a well-known or publicly known technique.

In the business transformation pattern definition table 390, a plurality of characteristics 393 are set in advance, and for the pattern name 392 (the element) corresponding to each characteristic 393, the simulation program ID 394 that applies the element to the As-Is business process to try to generate the To-Be (new) business process is set.

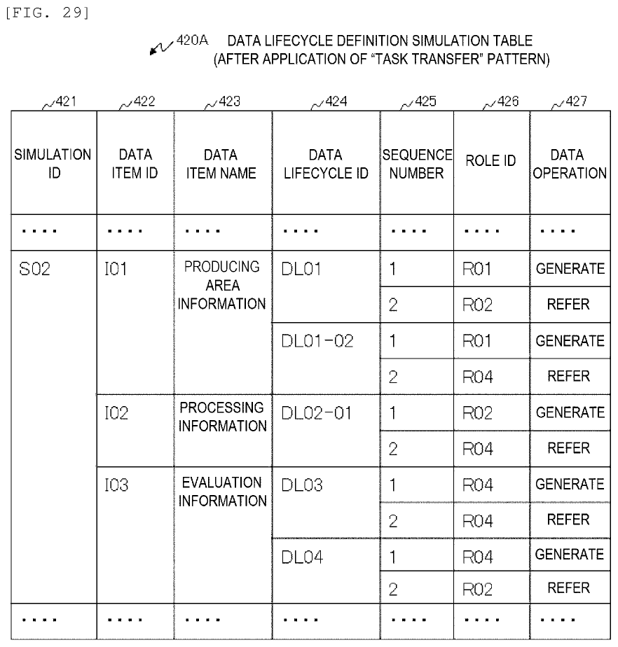

FIG. 28 is a diagram showing an example of the data lifecycle definition simulation table 420. The shown example shows a relationship between the data item and the role after the intermediator exclusion is applied as a business transformation pattern. The data lifecycle definition simulation table 420 is information generated by the program 270.

The data lifecycle definition simulation table 420 includes, in one record, a simulation ID 421 for storing an identifier of the simulation result, a data item ID 422 for storing the identifier of the data item, a data item name 423 for storing the item name of the data, a data lifecycle ID 424 for storing the identifier of the lifecycle of the data item, a sequence number 425 of the data item, a role ID 426 for storing the identifier of the role to handle the data item, and a data operation 427 for storing the operation to the data item to be performed by the role.

FIG. 29 is a diagram showing an example of a data lifecycle definition simulation table 420A after the task transfer. In the data lifecycle definition simulation table 420A, a relationship between the data item and the role after the program corresponding to the task transfer is applied as a program corresponding to the business transformation pattern is stored.

The configuration of each field is similar as that of the data lifecycle definition simulation table 420 shown in FIG. 28. The present embodiment shows an example of executing the “task transfer” after executing the “intermediator exclusion”.

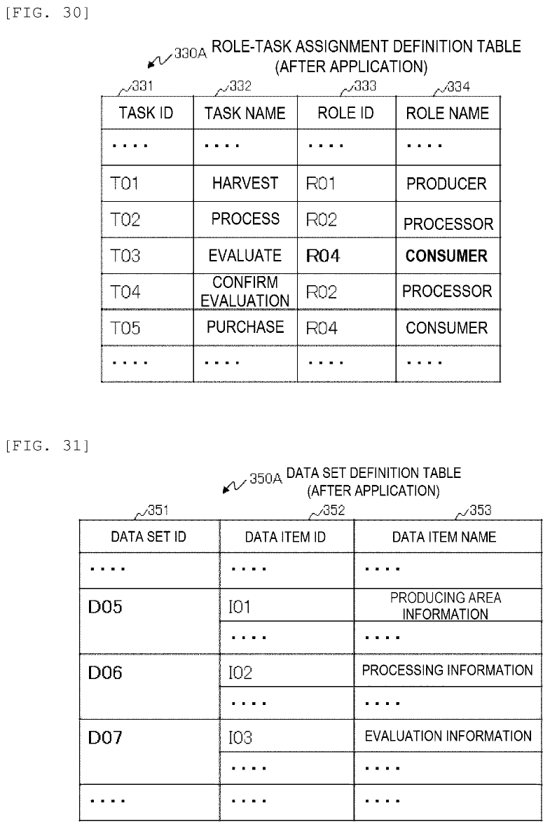

FIG. 30 is a diagram showing an example of a role-task assignment definition table 330A after the simulation result is applied. The role-task assignment definition table 330A shows an example in which the simulation result is applied to the role-task assignment definition table 330 in FIG. 19. The configuration of each field is similar as that of the role-task assignment definition table 330 shown in FIG. 19.

The bold part in the figure shows a part different from the role-task assignment definition table 330 shown in FIG. 19.

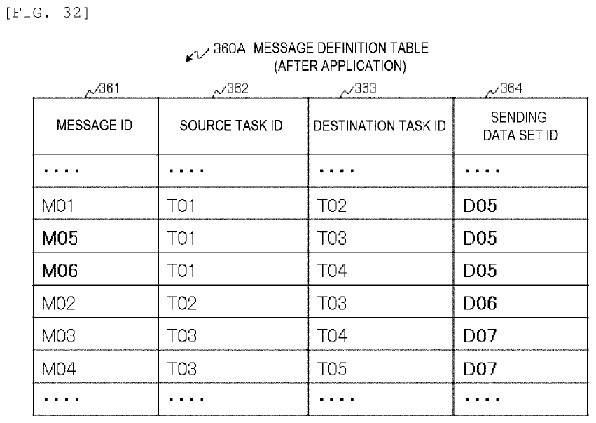

FIG. 31 is a diagram showing an example of a data set definition table 350A after the simulation result is applied. The data set definition table 350A shows an example in which the simulation result is applied to the role-task assignment definition table 350 in FIG. 21. The configuration of each field is similar as that of the data set definition table 350 shown in FIG. 21.

The bold part in the figure shows a part different from the data set definition table 350 shown in FIG. 21.

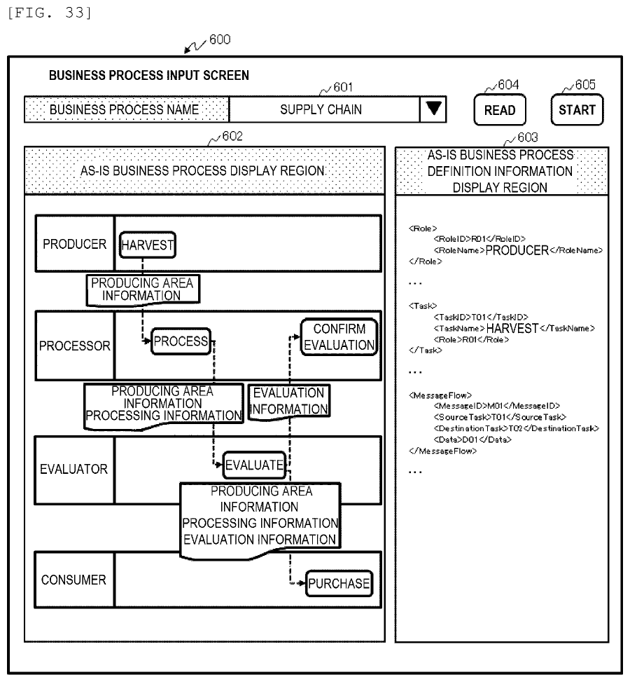

FIG. 32 is a diagram showing an example of a message definition table 360A after the simulation result is applied. The message definition table 360A shows an example in which the simulation result is applied to the message definition table 360 in FIG. 22. The configuration of each field is similar as that of the message definition table 360 shown in FIG. 22.

The bold part in the figure shows a part different from the message definition table 360 shown in FIG. 22.

### Details of Processing

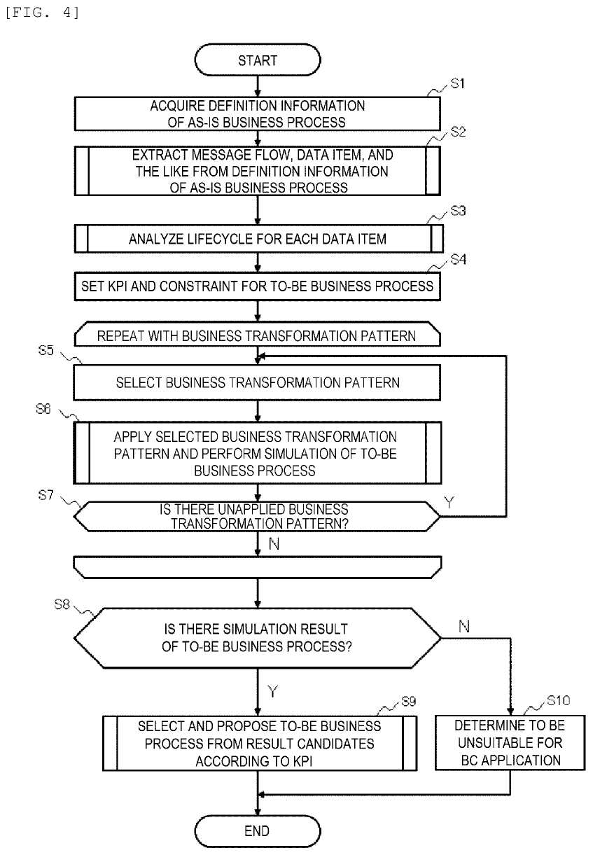

FIG. 4 is a flowchart showing an example of processing performed by the program 270 of the business process design support apparatus 100. This processing is executed based on a command from a user of the business process design support apparatus 100 or the management terminal 120.

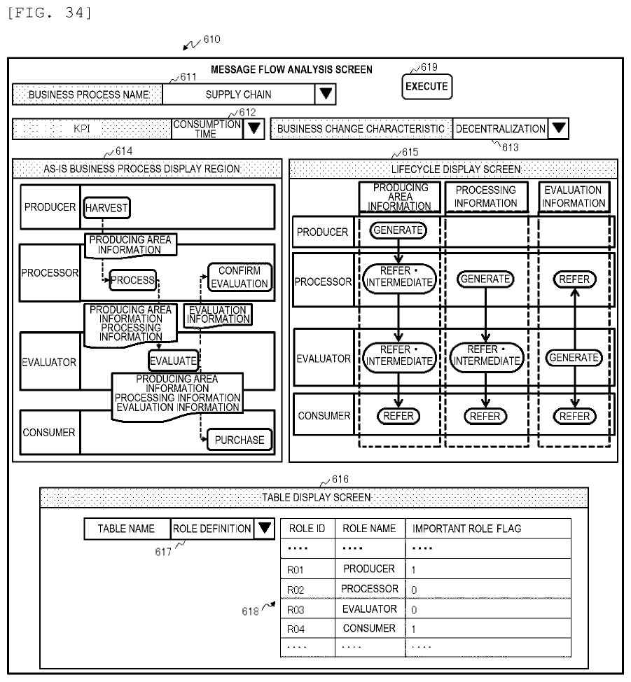

First, in step S1, the business process design support apparatus 100 displays a business process input screen 600 in FIG. 33 on the output device 250 to acquire definition information of the As-Is business process.

The business process input screen 600 in FIG. 33 includes a pull-down menu 601 for selecting an As-Is business process, a read button 604 for reading the selected As-Is business process, a start button 605 for starting a processing for the selected business process, an As-Is business process definition information display region 603 displaying the definition information of the selected As-Is business process, and an As-Is business process display region 602 indicating transition of information of the selected As-Is business process.

When the user of the business process design support apparatus 100 operates the input device 240 to select the As-Is business process from the pull-down menu 601 and operates the read button 604, contents of the As-Is business process selected in the pull-down menu 601 above are displayed in the As-Is business process display region 602 and the As-Is business process definition information display region 603.

In the As-Is business process definition information display region 603, information described in, for example, extensible markup language (XML) is displayed as the definition information of the As-Is business process. Then, when the start button 605 is operated, an analysis of the As-Is business process is started.

The business process design support apparatus 100 may receive the definition information of the As-Is business process as a file. Alternatively, the definition information of the As-Is business process may be acquired from the management terminal 120.

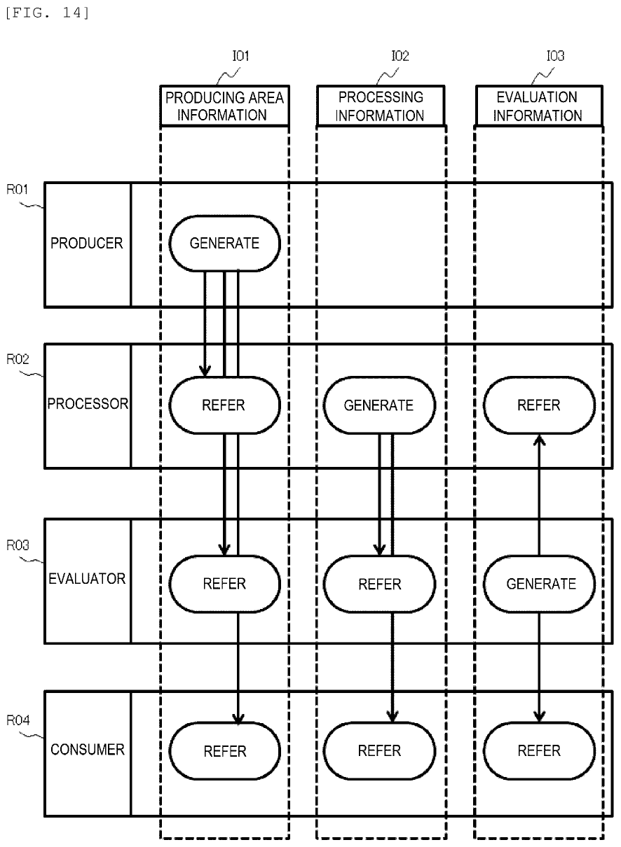

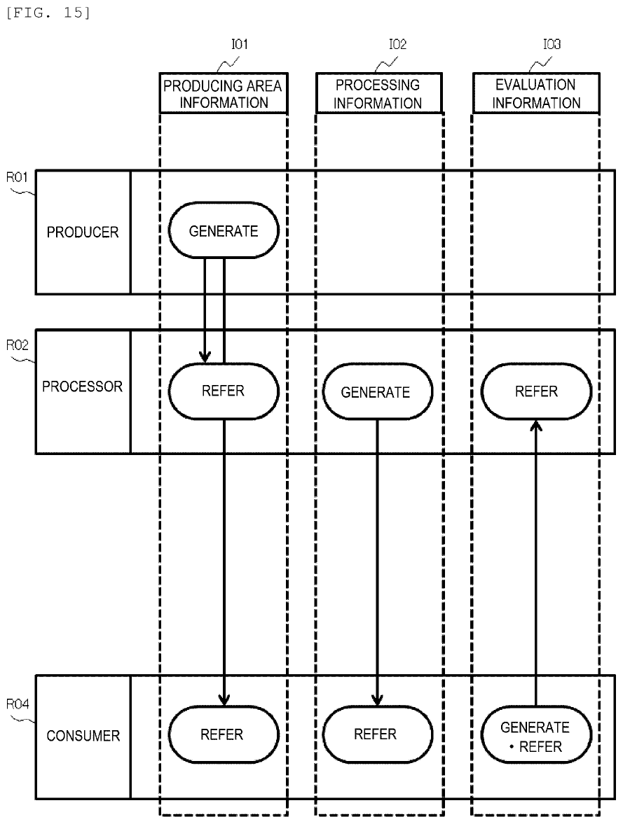

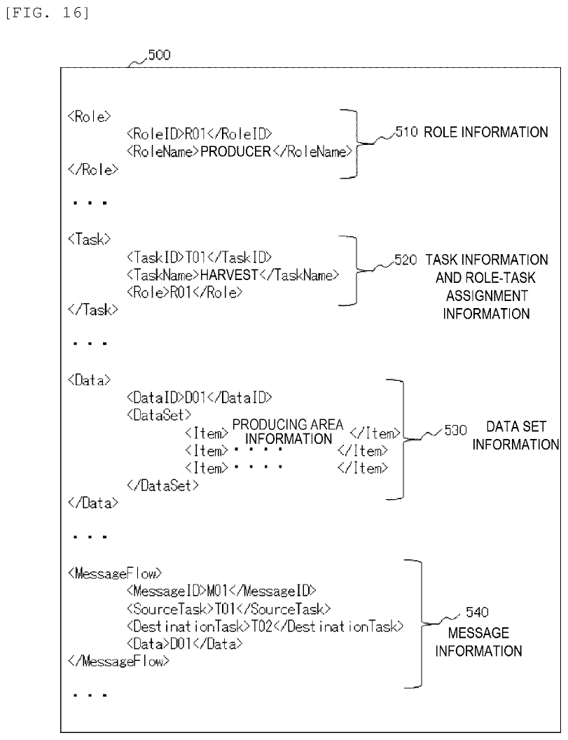

FIG. 16 shows an example of definition information 500 of the business process described in XML. A format of the definition information 500 of the business process can be applied to the As-Is business process and the To-Be business process.

The definition information 500 of the business process includes role information 510 defining roles, assignment information 520 defining a definition of the task and a relationship between the role and the task, data set information 530 including one or more data items, and message information 540 defining messages transmitted between the tasks.

Although not shown, the assignment information 520 includes a relationship between input and output of data items in each task. The definition information of the business process is not limited to the XML above, and can be described in a desired language or the like.

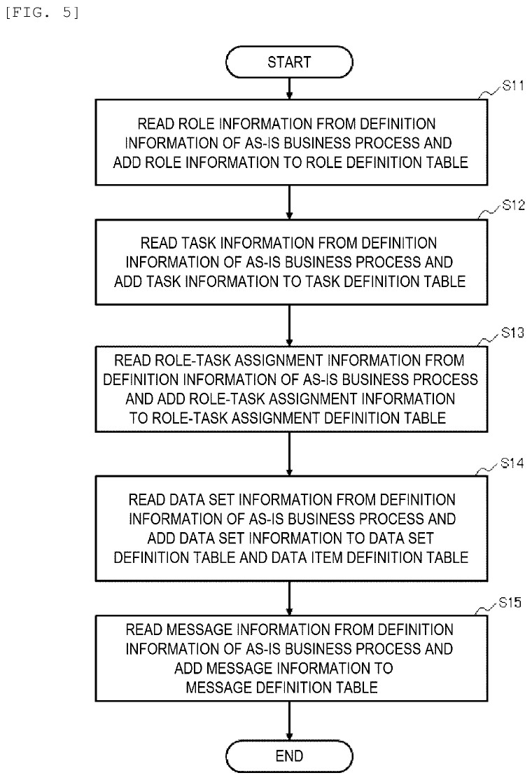

In step S2 in FIG. 4, the business process design support apparatus 100 extracts a definition of a message to be transmitted and received among the roles and a list of data items included in the message from the definition information 500 of the As-Is business process. Details of the analysis processing will be described below with reference to the flowchart in FIG. 5.

As a result of the analysis processing in FIG. 5, the business process design support apparatus 100 generates the role definition table 310, the task definition table 320, the role-task assignment definition table 330, the data item definition table 340, the data set definition table 350, and the message definition table 360.

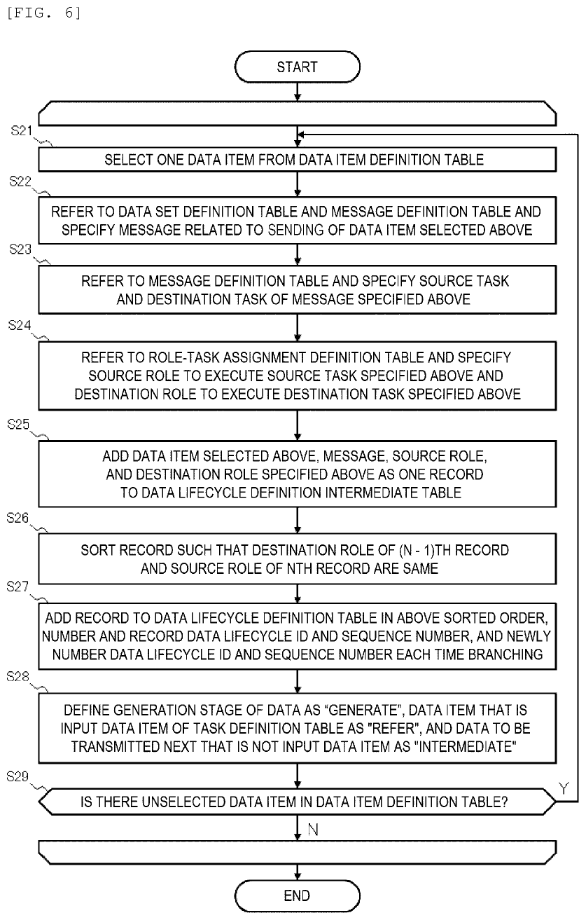

In step S3, the business process design support apparatus 100 analyzes the lifecycle of the data for each data item included in the message. Details of this processing will be described below with reference to FIG. 6. As a result of data lifecycle analysis processing, the business process design support apparatus 100 generates the data lifecycle definition intermediate table 400 and the data lifecycle definition table 410.

By the data lifecycle analysis processing, the definition information 500 of the business process shown in FIG. 16 is taken as an input to generate the data lifecycle definition table 410 shown in FIG. 26 as a model of the business process based on a content processed by the role for each data item and a relationship between sending and reception of a message among the roles.

Accordingly, the transition of the information of the As-Is business process shown in FIG. 11 is converted into a model from a role serving as a base point (a source) to a role serving as an end point of information sending for each data item as shown in FIG. 13, and contents of the data operation 416 executed by each role and an order (sequence number 414) of the information sending among the roles are analyzed.

FIG. 13 is a schematic diagram showing an example of the data lifecycle of the As-Is business process. In FIG. 13, operations (generate, refer, intermediate) executed by each role and a direction in which the data item is transmitted are modeled for each of the data items of the producing area information I01, the processing information 102, and the evaluation information 103. In the figure, a sending direction of the data item is displayed by a direction of an arrow.

For example, when the data item is the producing area information I01, the data item is generated by the producer R01 and then transmitted to the processor R02, and the processor R02 refers to the producing area information I01. The processor R02 intermediates with (transfers) the referred producing area information I01 to the evaluator R03.

The evaluator R03 refers to the received producing area information I01 and intermediates with the producing area information I01 to the consumer R04. The consumer R04 refers to the received producing area information I01. Thus, the producing area information I01 is intermediated to the consumer R04 serving as a role of an end point, with the producer R01 as a base point of the lifecycle.

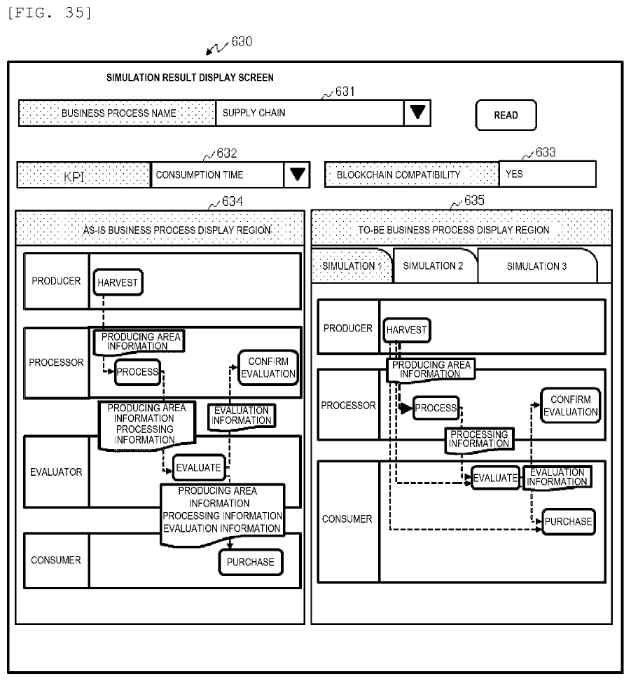

When a lifecycle analysis of the data item is completed, the business process design support apparatus 100 proceeds to step S4 in FIG. 4. In step S4, the business process design support apparatus 100 outputs a message flow analysis screen 610 shown in FIG. 34, and sets a KPI and a constraint for evaluating the To-Be business process.

The message flow analysis screen 610 in FIG. 34 includes a business process name 611 for displaying the As-Is business process, a pull-down menu 612 for selecting the KPI, a pull-down menu 613 for selecting a business transformation characteristic, an As-Is business process display region 614 indicating transition of information of the As-Is business process, a lifecycle display screen 615 for displaying a result of executing a data lifecycle analysis for the As-Is business process, and a table display screen 616 for displaying contents of a generated table.

The table display screen 616 includes a pull-down menu 617 for selecting a table and a table display region 618 for displaying a table to be selected. The name selected in the business process input screen 600 in FIG. 33 is displayed in the business process name 611. A KPI for evaluating the To-Be business process can be selected from the pull-down menu 612.

When the To-Be business process is planned, a role that is not desired to be excluded by the task transfer can be set as a constraint condition. In this case, it is possible to prevent the role from being excluded by the task transfer by selecting the role definition table 310 from the pull-down menu 617 and setting important role flag of a desired role to “1”. A condition for fixing the relationship between the role and the task may be added as the constraint condition.

The lifecycle display screen 615 showing the result of the data lifecycle analysis processing is the similar as that in FIG. 13, and a path from the role serving as the base point to the role serving as the endpoint is displayed for each data item.

In the As-Is business process display region 614, contents of the As-Is business process display region 602 displayed on the business process input screen 600 in FIG. 33 are displayed.

The user of the business process design support apparatus 100 operates an execution button 619 via the input device 240 to proceed to step S5 in FIG. 4 to try a simulation corresponding to the pattern name set in the business transformation pattern definition table 390 shown in FIG. 27.

In steps S5 to S7 in FIG. 4, the business process design support apparatus 100 sequentially selects pattern names 392 registered in the business transformation pattern definition table 390 in FIG. 27, executes the simulation program (PGMID 394) corresponding to the pattern ID 391, and tries to know how the To-Be business process obtained by applying the characteristic 393 of the blockchain to the As-Is business process changes to generate a simulation result.

In step S5, the business process design support apparatus 100 selects the PGMID 394 corresponding to an unprocessed pattern name 392 from the business transformation pattern definition table 390. Then, in step S6, the business process design support apparatus 100 executes the selected PGMID 394 to execute the simulation when the characteristics of the blockchain are applied to the As-Is business process.

In the present embodiment, an example is shown in FIG. 7 in which the intermediator exclusion processing with the pattern ID 391=“P01” is tried and an example is shown in FIG. 8 in which the task transfer processing with the pattern ID 391=“P02” is tried, and these details will be described below.

When the simulation is completed, the processing proceeds to step S7, in which the business process design support apparatus 100 determines whether there is an unapplied pattern among the pattern names 392 of the business transformation pattern definition table 390. If there is an unapplied pattern, the processing returns to step S5 and the business process design support apparatus 100 repeats the above processing, and if the simulation is completed for all the pattern names 392, the processing proceeds to step S8.

In step S8, the business process design support apparatus 100 determines whether a result of the To-Be business process is obtained as a result of executing each simulation program of the business transformation pattern definition table 390. When a business process different from the As-Is business process is obtained as the simulation result, the business process design support apparatus 100 determines that the To-Be business process is obtained, and the processing proceeds to step S9.

On the other hand, when the simulation result is the same as the As-Is business process or the business process cannot be generated, the business process design support apparatus 100 determines that the To-Be business process is not obtained, and the processing proceeds to step S10.

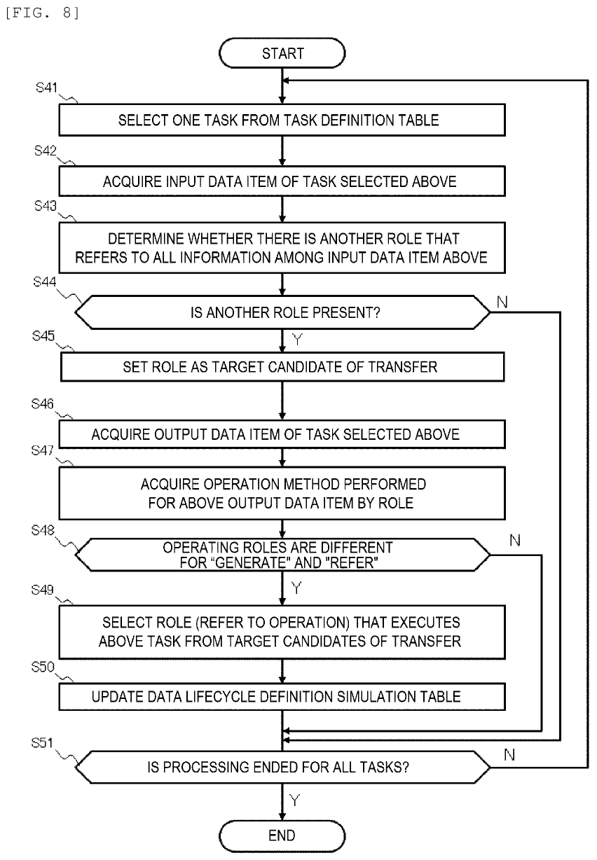

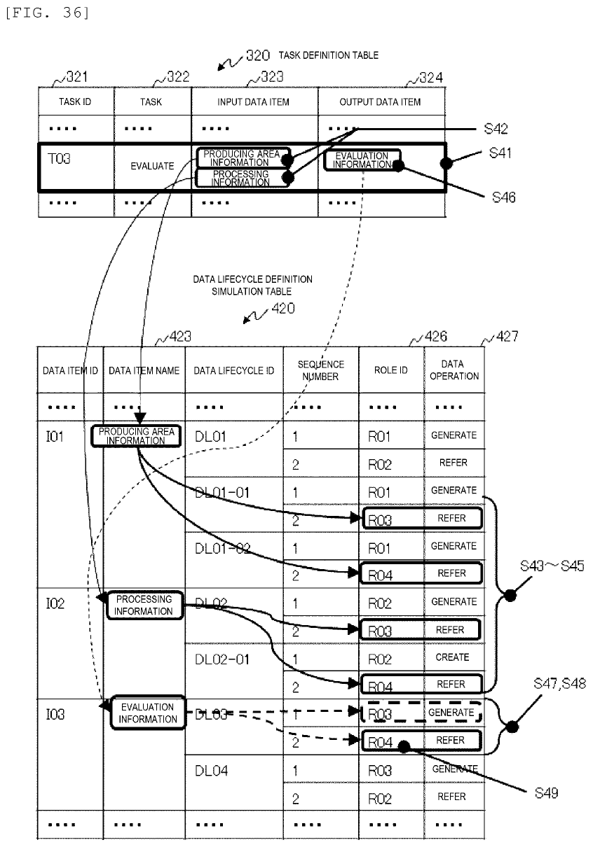

In step S9, the business process design support apparatus 100 selects the To-Be business process according to the KPI received in step S4, generates a simulation result display screen 620 shown in FIG. 35, and displays the simulation result display screen 620 on the output device 250. Selection processing of the To-Be business process based on the KPI will be described below with reference to the flowchart in FIG. 9.

On the other hand, in step S9, the business process design support apparatus 100 determines that a significant business process is not obtained even if the characteristics of the blockchain (the BC in the figure) are applied to the As-Is business process and outputs this result to the simulation result display screen 620.

By the above processing, with the simulation program set in the business transformation pattern definition table 390, it is possible to obtain a result of applying the characteristics of the blockchain to the As-Is business process, and it is possible to easily and quickly generate a plan of the To-Be business process. Accordingly, in planning the To-Be business process that can improve the As-Is business process, it is possible to prevent manual trial and error to efficiently improve the business process.

In the example in FIG. 4, the simulation program (the PGMID 394) corresponding to the pattern name 392 (or the pattern ID 391) of the business transformation pattern definition table 390 is tried one by one, but the invention is not limited thereto. For example, the user of the business process design support apparatus 100 or the management terminal 120 may select a plurality of characteristics 393 (pattern names 392) from the business transformation pattern definition table 390 to try the corresponding simulation program. The user may select a plurality of pattern names 392 to specify an order or combination of executing simulation programs.

For example, in the definition information of the As-Is business process, it is also possible to compare a simulation result of trying the “task transfer” on a result of trying the “intermediator exclusion” with a simulation result of trying the “intermediator exclusion” on a result of trying the “task transfer”.

### Business Process Analysis Processing

FIG. 5 is a flowchart showing an example of the As-Is business process analysis processing performed in step S2 in FIG. 4.

In step S11, the business process design support apparatus 100 acquires the role ID and the role name from the information (the role information 510 in FIG. 16) relating to the role of the definition information (definition information 500 of the business process in FIG. 16) of the As-Is business process acquired in the above step S1 to add records to the role definition table 310.

In step S12, the business process design support apparatus 100 acquires the task ID, the task name, the input data item, and the output data item from the information (the assignment information 520) relating to the task of the definition information 500 of the As-Is business process to add records to the task definition table 320.

In step S13, the business process design support apparatus 100 acquires the task ID and the role ID from the information (the assignment information 520) relating to the task and the role of the definition information 500 of the As-Is business process to add records to the role-task assignment definition table 330.

In step S14, the business process design support apparatus 100 acquires the data set ID, the data item ID, and the data item name from the information (the data set information 530) relating to the data set of the definition information 500 of the As-Is business process to add records to the data item definition table 340 and the data set definition table 350. When the data item ID is not included in the definition information 500 of the As-Is business process, the business process design support apparatus 100 may attach the data item ID.

In step S15, the business process design support apparatus 100 acquires the message ID, the source task ID, the destination task ID, and the data set ID from the information (the message information 540) relating to the message of the definition information 500 of the As-Is business process to add records to the message definition table 360.

By the above processing, the role definition table 310, the task definition table 320, the role-task assignment definition table 330, the data item definition table 340, the data set definition table 350, and the message definition table 360 are generated for defining the As-Is business process.

FIG. 6 is a flowchart showing an example of the data lifecycle analysis processing executed in step S3 in FIG. 4. Instep S21, the business process design support apparatus 100 selects one unprocessed data item ID 341 from the data item definition table 340.

In step S22, the business process design support apparatus 100 refers to the data set definition table 350 and the message definition table 360 to specify the message ID 361 including the selected data item ID.

When the business process design support apparatus 100 selects the data item ID 341=“I01” (the data item name=the producing area information), D01, D02, and D04 are acquired as the data set ID 351 including I01 in the data item ID 352 from the data set definition table 350.

The business process design support apparatus 100 refers to the message definition table 360 to specify M01, M02, and M04 as the message ID 361 including D01, D02, and D04 in the sending data set ID 364. Accordingly, it is specified that the data item of the “producing area information” is included in the message ID=“M01”, “M02”, and “M04”.

In step S23, the business process design support apparatus 100 refers to the message definition table 360 to specify the source task ID and the destination task ID of the message ID specified in the above step S22. The business process design support apparatus 100 specifies “T01, T02”, “T02, T03” and “T03, T05” as pairs of the source task ID 362 and the destination task ID 363 based on the above message ID=“M01”, “M02”, and “M04”.

In step S24, the business process design support apparatus 100 refers to the role-task assignment definition table 330 to specify a role to execute the source task ID 362 and a role to execute the destination task ID 363 that are specified in the above step S23. The business process design support apparatus 100 specifies the role ID 333=“R01” to “R04” based on the task ID specified in the above step S23.

In step S25, the business process design support apparatus 100 adds the data item ID and data item name selected above, and the message ID, the source role ID, and the destination role ID that are specified above as one record to the data lifecycle definition intermediate table 400.

In step S26, the business process design support apparatus 100 sorts the record such that the destination role ID 404 of an (N−1)th record and the source role ID 403 of an Nth record are the same in units of the data item ID 401 added to the data lifecycle definition intermediate table 400.

In step S27, the business process design support apparatus 100 holds the record added to the data lifecycle definition intermediate table 400 in step S25 in an order sorted in step S26 to add the record to the data lifecycle definition table 410.

Then, for the record added to the data lifecycle definition table 410, the business process design support apparatus 100 attaches the data lifecycle ID 413 for each data item ID, and attaches the sequence number 414 in a sorted order in the same data lifecycle ID 413.

When the destination role ID 404 of the (N−1)th record and the source role ID 403 of the Nth record are not the same in the data lifecycle definition intermediate table 400, since message branching occurs, the business process design support apparatus 100 attaches a different data lifecycle ID 413 in the data item ID 411, and numbers the sequence number 414 in the data lifecycle ID 413.

For example, in the data lifecycle definition intermediate table 400, the source role ID 403 of the evaluation information (I03) branches from one “R03” to two destination role IDs 404=“R02” and “R04”. Therefore, in the data lifecycle definition intermediate table 400, two data lifecycle IDs=“DL03” and “DL04” are numbered in the data item ID 411 of the evaluation information, and are managed in accordance with the branch of the destination.

Next, in step S28, the business process design support apparatus 100 sets a type of operation of the data item executed by each role. Since the data item is generated in the role ID 415 serving as a start point (the sequence number 414=1) of the data item ID 411, “generate” is set in the data operation 416.

Then, the business process design support apparatus 100 refers to the task definition table 320 and the role-task assignment definition table 330 for each role ID 415 to set, if the data item name corresponding to the data item ID 411 is present in the input data item 323 of the task definition table 320, “refer” in the data operation 416. Further, when the input data item 323 is transmitted to another role, “transfer” is set in the data operation 416.

In the role in which the data item name is present in the input data item 323 of the task definition table 320 and the data item is transmitted to another role, “refer, transfer” is set in the data operation 416.

In step S29, if there is any unprocessed record in records of the data item definition table 340, the processing returns to step S21 and the above processing is repeated. On the other hand, when the processing is completed for all the records, the flowchart is ended and the processing returns to that in FIG. 4.

By executing the above processing, an analysis of each definition table generated from the definition information of the As-Is business process is executed to set, for each data item (data item ID and data item name), a role ID serving as an end point of the message based on a role serving as a start point of the message and a type of operation for the data item in each role ID in the data lifecycle definition table 410.

The data lifecycle definition table 410 can be handled as information indicating a model of the business process based on a definition of the business process. That is, it is possible to generate the model of the business process as shown in FIG. 11 based on the data items used in the business process, the order (the sequence number 414) of the roles using the data items, and the operation of each role for the data item.

### Intermediator Exclusion Processing

FIG. 7 is a flowchart showing an example of the intermediator exclusion processing performed in step S6 in FIG. 4. This processing is executed when the pattern ID 391=“P01” in the business transformation pattern definition table 390 is selected in step S5 in FIG. 4.

First, in step S31, the business process design support apparatus 100 refers to the data lifecycle definition table 410 to specify a record whose data operation 416 is only “intermediate”.

Next, in step S32, the business process design support apparatus 100 refers to the role definition table 310 for the role ID 415 of the record specified in step S31, and determines whether the important role flag 313 is set to “1” (=an important role). If the important role flag 313 is set to “1”, the processing proceeds to step S34, and if not, the processing proceeds to step S33.

In step S33, the business process design support apparatus 100 deletes a record whose data operation 416 is only “intermediate” and is not specified as an important role.

In step S34, the business process design support apparatus 100 deletes the “intermediate” from a record including the data operation other than “intermediate” in the data operation 416 from the data lifecycle definition table 410.

In step S35, the business process design support apparatus 100 determines whether a record whose data operation 416 is “refer” with a sequence number 414 other than an end point of each data lifecycle ID 413 is present. If a record whose data operation 416 is “refer” with the sequence number 414 other than the end point is present, the processing proceeds to step S36, and if not, the processing is ended.

In step S36, the business process design support apparatus 100 divides a data lifecycle such that a data operation 416 of a first sequence number 414 is “generate” and a data operation 416 of a last sequence number 414 is “refer”, and numbers the data lifecycle ID 413 to number the sequence number 414 again.

Then, the business process design support apparatus 100 writes contents of the data lifecycle definition table 410 into the data lifecycle definition simulation table 420 in FIG. 28 to set an identifier of a simulation result of the intermediator exclusion to the simulation ID 421.

By executing the above processing, the information including the data item is directly transmitted from a role generating the data item to a role referring to the data item, excluding a role other than an important role among roles of only “intermediate”. Accordingly, it is possible to share information by roles that participate in the business process, and it is possible to secure the decentralization and the transparency. Since the information can be shared by the roles that participate in the business process, even if a fault occurs in one role, it is possible for the other roles to acquire information including the data item, and to increase the fault tolerance.

As a result of the above processing, the data lifecycle definition table 410 shown in FIG. 26 is updated as shown in FIG. 28, the processing of “intermediate” is excluded from the data operation 416 of each role, and the information including the data item is transmitted from the role generating the data item to the role referring to the data item.

The data lifecycle definition simulation table 420 in FIG. 28 indicates that the data lifecycle ID 424 is divided into a plurality of pieces, and in one data lifecycle ID 424, the role ID 426 of “generate” and the role ID 426 of “refer” are associated with each other so that the information including the data item name is directly transmitted.

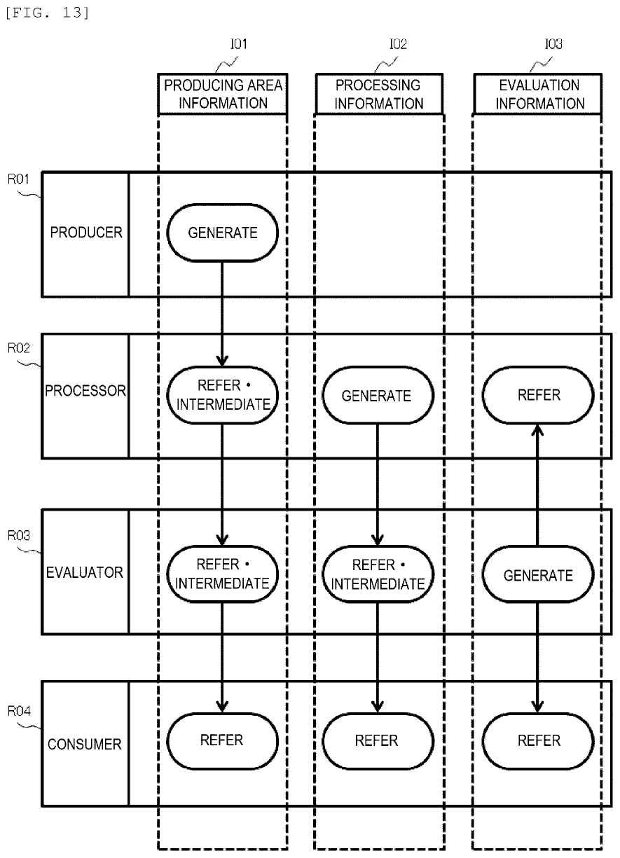

As a result, a data lifecycle of the To-Be business process obtained by the intermediator exclusion processing is changed as shown in FIG. 14. FIG. 14 is a schematic diagram showing an example of the data lifecycle after the intermediator exclusion. For example, the producing area information I01 generated by the producer R01 is directly transmitted to the processor R02, the evaluator R03, and the consumer R04 that refer to the information. The similar applies to the other roles.

### Task Transfer Processing

FIG. 8 is a flowchart showing an example of the task transfer processing performed in step S6 in FIG. 4. This processing is executed when the pattern ID 391 in the business transformation pattern definition table 390=“P02” is selected in step S5 in FIG. 4.

First, in step S41, the business process design support apparatus 100 selects one task 322 from the task definition table 320. Next, in step S42, the business process design support apparatus 100 acquires the input data item 323 of the task selected above.

In step S43, the business process design support apparatus 100 refers to the task definition table 320 and the role-task assignment definition table 330 to determine whether another role that refers to all the information included in the input data item 323 acquired above is present. Here, another role indicates a role downstream from the role that executes the task selected in the above step S41 in the As-Is business process shown in FIG. 11. In the shown example, a source of information is set upstream, and a destination of the information is set downstream.

In step S44, when the business process design support apparatus 100 determines another role that refers to all the information of the input data item 323 is present, the processing proceeds to step S45, and if not, the processing proceeds to step S51.

In step S45, the business process design support apparatus 100 sets the role as a target candidate of the task transfer. In step S46, the business process design support apparatus 100 refers to the task definition table 320 to acquire the output data item 324 of the task selected in the above step S41.

In step S47, the business process design support apparatus 100 refers to the data lifecycle definition table 410 to acquire contents of the data operation 416 executed for the output data item 324 acquired in the above step S46 by the role which is the target candidate of the task transfer.

In step S48, the business process design support apparatus 100 determines whether a role that executes “generate” and a role that executes “refer” for the output data item 324 are different roles. If the roles are different, the processing proceeds to step S49 in order to execute the task transfer, and if not, the processing proceeds to step S51.

In step S49, the business process design support apparatus 100 selects, as a destination of the task transfer, a role that executes the task for generating the output data item 324, and a role that refers to the output data item 324 among target candidates of the transfer.

In step S50, the business process design support apparatus 100 moves the task for generating the output data item 324 to the role selected in step S49 to update or generate the data lifecycle definition simulation table 420. The movement of the task is a movement of the task from a role of a movement source to a role of a movement destination, and when no task is executed by the role of the movement source, the role of the movement source is deleted.

If the task transfer processing is a first simulation, the business process design support apparatus 100 writes a result of the movement of the role in the contents of the data lifecycle definition table 410 into the data lifecycle definition simulation table 420A. The business process design support apparatus 100 sets an identifier of the task transfer processing in the data lifecycle definition simulation table 420A.

On the other hand, when the task transfer processing is not the first simulation, the business process design support apparatus 100 writes the result of the movement of the role in contents of the data lifecycle definition simulation table 420 holding the previous simulation result in the data lifecycle definition simulation table 420A.

In step S51, the business process design support apparatus 100 determines whether the processing is completed for all tasks in the task definition table 320. If the processing is completed, the flowchart is ended, and if not, the processing returns to the above step S41 and the above processing is executed for an unprocessed task.

A specific example of the above processing will be described. FIG. 36 is a diagram showing an example of the task transfer processing. In the shown example, “evaluate” is selected as the task 322 in the above step S41.

Next, in step S42, “producing area information” and “processing information” are selected from the input data item 323 with an entry of the task 322=“evaluate”. Then, in the data lifecycle definition simulation table 420, the role ID 426 that refers to the “producing area information” downstream from the role (R03) executing “evaluate” is “R03” and “R04”.

In the data lifecycle definition simulation table 420, the role ID 426 that refers to the “processing information” downstream from the role (R03) executing “evaluate” is “R03” and “R04”.

In step S43, “R03” and “R04” of the role ID 426 are roles of the target candidates of the transfer.

Next, in step S46, the “evaluation information” is acquired from the output data item 324 with the entry of the task 322=“evaluate”. In step S47, the contents of the operation executed by the role ID of the target candidates of the transfer=“R03” and “R04” for the “evaluation information” is acquired from the data operation 427. Here, the data operation 427 executed by the role ID=“R03” is “generate” and the data operation 427 executed by the role ID=“R04” is “refer”.

Then, in steps S47 and S48, since the role of “generate” and the role of “refer” are different roles=“R03” and “R04”, the task 322=“evaluate” is moved from the role ID=“R03” to the role ID=“R04”.

Accordingly, as shown in FIG. 12, by moving the task executed by one role to another role, it is possible to implement the business process of the decentralization.

As shown in FIG. 29, in the data lifecycle definition simulation table 420A, the evaluation information is generated with the role ID=“R04”, and a relationship between the task and the role is updated so that the evaluation information is referred by the role ID=“R02” and the role ID=“R04” (own). In FIG. 29, the role ID=“R03” with no task is deleted.

As a result of the intermediator exclusion processing and the task transfer processing, the As-Is business process shown in FIG. 13 is updated to a simple configuration as shown in FIG. 15. FIG. 15 is a schematic diagram showing an example of a data lifecycle after the task transfer.

The role of the evaluator R03 is deleted, and the producing area information I01 is directly transmitted to the processor R02 and the consumer R04. The generation of the evaluation information is moved from the evaluator R03 to the consumer R04, and the evaluation information 103 is transmitted from the consumer R04 to the processor R02.

### Selection Processing

FIG. 9 is a flowchart showing an example of the selection processing based on the KPI performed in step S9 in FIG. 4. This processing is executed after the characteristics of the blockchain are determined to be applicable in step S8 in FIG. 4. This processing is executed based on the KPI received in step S4 in FIG. 4.

In step S61, the business process design support apparatus 100 refers to the message sending cost calculation table 370 and the task execution cost calculation table 380 to calculate the consumption amount and the consumption time in the business process as the simulation result.

In step S62, the business process design support apparatus 100 selects a simulation result in which the KPI (the index of the cost, such as the consumption amount and the consumption time) received in step S4 in FIG. 4 above is minimized.

In step S63, the business process design support apparatus 100 updates the data lifecycle definition table 410, the role-task assignment definition table 330A, the data set definition table 350A, and the message definition table 360A using the selected simulation result.

The data lifecycle definition table 410 is updated with the contents of the data lifecycle definition simulation table 420A shown in FIG. 29. In the role-task assignment definition table 330A, as shown in FIG. 30, the role ID with the task ID =“T03” is updated to “R04”, and the role name is updated to “consumer”. This is because the role of the evaluator R03 is deleted by executing the task transfer processing.

In addition, as shown in FIG. 31, in the data set definition table 350A after the simulation result is applied, the data set ID 351 with the data item ID 352=“I01” is updated to “D05”. The data set IDs with the data item IDs=“I02” and “I03” are also updated to “D06” and “D07”.

Then, the message definition table 360A after the simulation result is applied is updated as shown in FIG. 32. The sending data set IDs 364 with the message IDs=“M01” to “M04” shown in FIG. 22 are updated, and new message IDs “M05” and “M06” are added.

Next, in step S64, the business process design support apparatus 100 updates the definition information 500 of the business process described in XML along with the updating of the above tables to which simulation results are applied.

In step S65, the business process design support apparatus 100 generates a simulation result display screen 630 including the To-Be business process and displays the simulation result display screen 630 on the output device 250. FIG. 35 is a diagram showing an example of the simulation result display screen 630.

The simulation result display screen 630 includes a business process name 631, a specified KPI 632, a blockchain compatibility 633, an As-Is business process display region 634 indicating the transition of the information of the As-Is business process, and a To-Be business process display region 635 displaying the simulation result as the To-Be business process.

In the As-Is business process display region 634, the contents of the As-Is business process display region 602 displayed on the business process input screen 600 in FIG. 33 are displayed. In the To-Be business process display region 635, a diagram showing an example of the transition of the information of the To-Be business process shown in FIG. 12 is displayed.

Although the simulation result to be applied is selected using the KPI in the above embodiment, the simulation result to be applied may be selected on the simulation result display screen 630. In the simulation result display screen 630, the simulation result may be sorted and displayed in an ascending order of the KPI (the cost).

### Pattern Addition Processing

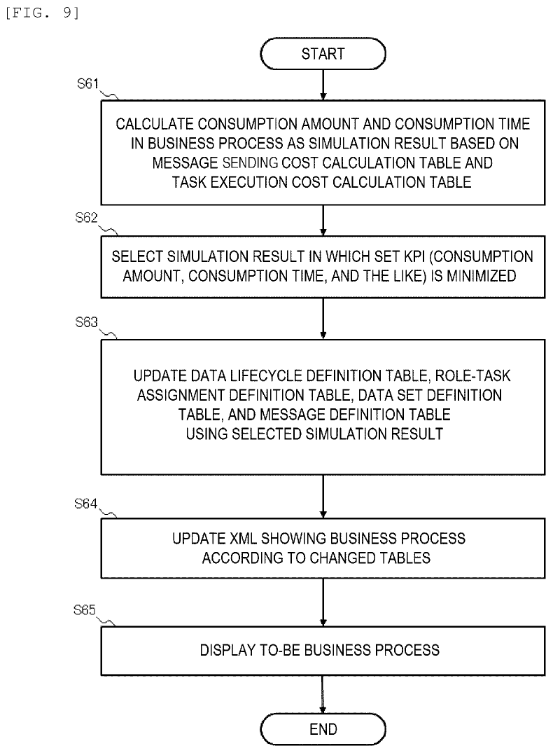

FIG. 10 is a flowchart showing an example of pattern addition processing. This processing is executed by a command of the manager or the like of the business process design support apparatus 100.

In step 71, the business process design support apparatus 100 receives a characteristic of the blockchain utilized by a new business transformation pattern, a pattern name, and an ID of a simulation program corresponding to the characteristic.

In step 72, the business process design support apparatus 100 adds a new record to the business transformation pattern definition table 390 to attach the pattern ID 391 and set the received pattern name, the characteristic, and the ID of the simulation program.

By executing the above processing, it is possible to update the business transformation pattern using the characteristics of the blockchain at any time.

### Overview

The invention is not limited to the above embodiment, and includes various modifications. For example, the above-described embodiment is described in detail for easy understanding of the invention, and the invention is not necessarily limited to those including all the configurations described above. A part of the configurations according to one embodiment can be replaced with the configurations according to another embodiment, and the configurations according to another embodiment can be added to the configurations according to one embodiment. For a part of the configurations according to each embodiment, addition, deletion, or replacement of another configuration may be applied alone or in combination.

Some or all of the above-described configurations, functions, processing units, processing methods, and the like maybe implemented by hardware, for example, by designing some or all of the above-described configurations, functions, processing units, processing methods, and the like with an integrated circuit. The above-described components, functions, and the like may also be implemented by software by a processor interpreting and executing programs for implementing the functions. Information such as a program, a table, and a file for implementing each function can be stored in a recording device such as a memory, a hard disk, or a solid state drive (SSD), or in a recording medium such as an IC card, an SD card, or a DVD.

Control lines or information lines indicate what is considered necessary for description, and not all the control lines or information lines are shown in a product. Almost all the configurations may be considered to be actually connected to one another.

1. A business process design support method for supporting a design of a business process by a computer including a processor, a memory, and a storage device, the business process design support method comprising:
a first step of the computer receiving definition information of the business process;
a second step of the computer extracting one or more data items, one or more roles to execute processing, contents of tasks to be processed by the role for each data item, and a relationship between sending and reception of a message among roles from the definition information to generate a model of the business process;
a third step of the computer selecting an element of information management set in advance;
a fourth step of the computer executing a simulation to apply the selected element of information management to the model; and
a fifth step of the computer determining whether the selected element of information management is applicable to the model based on results of the simulation.

2. The business process design support method according to claim 1, wherein
the element of information management is an element included in distributed information management,
in the fourth step, a selected element of the distributed information management is applied to the model to try to generate a model of a new business process, and
in the fifth step, when the model of a new business process is generated by the simulation, the element of the distributed information management is determined to be applicable to the business process.

3. The business process design support method according to claim 2, wherein
a plurality of elements of the distributed information management are set in advance, and the simulation is set for each of the plurality of elements,
in the third step, one or more elements are selected from the plurality of elements, and
in the fourth step, simulations corresponding to the selected one or more elements are executed.

4. The business process design support method according to claim 3, wherein
in the simulation, a role having a task only of intermediating with the message is deleted.

5. The business process design support method according to claim 3, wherein
the simulation extracts a movable task among the tasks, and moves the extracted task to another role.

6. The business process design support method according to claim 3, further comprising:
a sixth step of the computer receiving an index of cost for executing the tasks to calculate cost for the results of the simulation and to select a result of the simulation in which the cost is minimized from the results of the simulation.

7. A business process design support apparatus including a processor, a memory, and a storage device to support a design of a business process, wherein
the processor receives definition information of the business process and extracts, from the definition information, a data item, a role to execute processing, contents of tasks to be processed by the role for each data item, and a relationship between sending and reception of a message among roles to generate a model of the business process,
the processor selects an element of information management set in advance to execute a simulation to apply the selected element of information management to the model, and
the processor determines whether the selected element of information management is applicable to the model based on results of the simulation.

8. The business process design support apparatus according to claim 7, wherein
the element of information management is an element included in distributed information management,
in the simulation, a selected element of the distributed information management is applied to the model to try to generate a model of a new business process, and
in determining whether the selected element is applicable to the model, when the model of the new business process is generated by executing the simulation, the element of the distributed information management is determined to be applicable to the business process.

9. The business process design support apparatus according to claim 8, wherein
a plurality of elements of the distributed information management are set in advance, and the simulation is set for each of the plurality of elements,
in selection of the element of the distributed information management, one or more elements are selected from the plurality of elements, and
in the simulation, simulations corresponding to the selected one or more elements are executed.

10. The business process design support apparatus according to claim 9, wherein
in the simulation, a role having a task only of intermediating with the message is deleted.
